(19) United States
(12) Patent Application Publication
(10) Pub. No.: US 2020/0104863 A1
(43) Pub. Date: Apr. 2, 2020

(54) SYSTEMS AND METHODS FOR MANAGING A RETAIL ENVIRONMENT

(71) Applicant: Johnson Controls Technology Company, Auburn Hills, MI (US)

(72) Inventors: Anushka Gupta, Kumarapatnam (IN); Shrey Ostwal, Savedi Ahmednagar (IN); Ankur Thareja, Alwar (IN); Amandeep Singh Johar, Bareilly (IN); Avinash Shreekant Bhate, Bhosari (IN)

(73) Assignee: Johnson Controls Technology Company, Auburn Hills, MI (US)

(21) Appl. No.: 16/562,199

(22) Filed: Sep. 5, 2019

(30) Foreign Application Priority Data
Sep. 7, 2018 (IN) 201841033782

(51) Int. Cl. G06Q 30/02; G06Q 20/20; G06K 7/14

(52) U.S. Cl. CPC G06Q 30/0201; G06K 7/1413; G06Q 20/208

(57) ABSTRACT

A method for managing a retail environment includes identifying a plurality of shopping carts traveling through an aisle of a retail environment; retrieving information of respective times of the plurality of shopping carts entering the aisle, and respective times of the plurality of shopping carts leaving the aisle; associating the plurality of shopping carts with respective transaction identifications; generating a database comprising the transaction identifications and respective items, the items of each transaction identification comprising at least a dwell time class, respective purchase states of one or more products deployed along the aisle, and respective query states of the one or more product; calculating a respective product conversion rate of each of the transaction identifications based on the database; and providing an aisle product conversion rate for managing product placements in the retail environment based on the respective product conversion rate of each of the transaction identifications.

### CROSS-REFERENCE TO RELATED APPLICATIONS

This application claims the benefit of the following provisionally filed Indian patent application: Application No. 201841033782, filed on Sep. 7, 2018, the entire content of which is incorporated herein by reference.

### TECHNICAL FIELD

The present disclosure relates generally to a retail environment. The present disclosure relates more particularly to systems and methods for managing a retail environment.

### BACKGROUND

The locations of products in a shopping facility or a retail environment (which is typically referred to as a Brick and Mortar retail store) are typically determined based in part on popularity, type, and power supply needs, etc. Difficulty in finding a product can lead to unnecessarily lengthy shopping trips and frustration in customers. Unlike online shopping sites, customer expectation and/or respective product conversion rates are typically difficult to track, which makes allocating products within the retail environment challenging. Thus, there exists a need to allow the administrator of a retail environment to better manage respective product conversion rates of the products in the retail environment.

### SUMMARY

According to some aspects, embodiments relate to systems and methods for managing a retail environment. In one aspect, the method can include identifying a plurality of shopping carts traveling through an aisle of a retail environment. The method can include retrieving information of respective times of the plurality of shopping carts entering the aisle, and respective times of the plurality of shopping carts leaving the aisle. The method can include associating the plurality of shopping carts with respective transaction identifications. The method can include generating a database comprising the transaction identifications and one or more respective items, the one or more items of each transaction identification comprising at least one of a dwell time class, respective purchase states of one or more products deployed along the aisle, or respective query states of the one or more products. The method can include calculating a respective product conversion rate of each of the transaction identifications based on the database. The method can include providing an aisle product conversion rate for managing product placements in the retail environment based on the respective product conversion rate of each of the transaction identifications.

In some embodiments, calculating a respective product conversion rate of each of the transaction identifications can further include dividing a number of products, associated with each of the transaction identifications, that are queried and purchased by a number of products, associated with each of the transaction identifications, that are queried.

In some embodiments, the method can further include determining the number of products, associated with each of the transaction identifications, that are queried and purchased according to the respective purchase states of one or more products associated with the transaction identification and the respective query states of the one or more products associated with the transaction identification. The method can further include determining the number of products, associated with the transaction identification, that are queried according to the respective query states of the one or more products associated with the transaction identification.

In some embodiments, the method can further include calculating respective dwell times spent by the plurality of shopping carts traveling through the aisle based on the respective times of the plurality of shopping carts entering the aisle and respective times of the plurality of shopping carts leaving the aisle. The method can further include grouping the plurality of shopping carts into respective dwell time classes.

In some embodiments, the method can further include filtering out one or more shopping carts from the database, responsive to their respective dwell times being less than a pre-defined threshold.

In some embodiments, the plurality of shopping carts are each attached with at least one of a radio-frequency identification tag or a beacon-enabled device, and a barcode.

In some embodiments, retrieving the information of respective times of the plurality of shopping carts entering the aisle and respective times of the plurality of shopping carts leaving the aisle can further include receiving signals provided by one or more wireless devices deployed along the aisle, responsive to the plurality of shopping carts entering and leaving the aisle, respectively.

In some embodiments, associating the plurality of shopping carts with respective transaction identifications can further include receiving signals provided from one or more point-of-sale systems, responsive to the respective bar codes being scanned at the one or more point-of-sale systems.

In some embodiments, the method can further include receiving the respective query states of the one or more products associated with each of the transaction identifications, responsive to receiving identifications of the plurality of shopping carts from a virtual private assistant.

In some embodiments, the method can further include based on the database, using an association rule learning technique to estimate a confidence value indicative of a query behavior of a product placed in the aisle.

In some embodiments, the method can further includes taking an action to update a location of the product, responsive to receipt of the confidence value.

In another aspect, the system can include one or more hardware processors. The one or more hardware processors can be configured by machine-readable instructions to: identify a plurality of shopping carts traveling through an aisle of a retail environment; retrieve information of respective times of the plurality of shopping carts entering the aisle, and respective times of the plurality of shopping carts leaving the aisle; associate the plurality of shopping carts with respective transaction identifications; generate a database comprising the transaction identifications and one or more respective items, the one or more items of each transaction identification comprising at least one of: a dwell time class, respective purchase states of one or more products deployed along the aisle, and respective query states of the one or more products; calculate a respective product conversion rate of each of the transaction identifications based on the database; and provide an aisle product conversion rate for managing product placements in the retail environment based on the respective product conversion rate of each of the transaction identifications.

In some embodiments, the one or more hardware processors can be further configured by machine-readable instructions to divide a number of products, associated with each of the transaction identifications, that are queried and purchased by a number of products, associated with each of the transaction identifications, that are queried.

In some embodiments, the one or more hardware processors can be further configured by machine-readable instructions to determine the number of products, associated with each of the transaction identifications, that are queried and purchased according to the respective purchase states of one or more products associated with the transaction identification and the respective query states of the one or more products associated with the transaction identification. The one or more hardware processors can be further configured by machine-readable instructions to determine the number of products, associated with the transaction identification, that are queried according to the respective query states of the one or more products associated with the transaction identification.

In some embodiments, the one or more hardware processors can be further configured by machine-readable instructions to calculate respective dwell times spent by the plurality of shopping carts traveling through the aisle based on the respective times of the plurality of shopping carts entering the aisle and respective times of the plurality of shopping carts leaving the aisle. The one or more hardware processors can be further configured by machine-readable instructions to group the plurality of shopping carts into respective dwell time classes.

In some embodiments, the one or more hardware processors can be further configured by machine-readable instructions to filter out one or more shopping carts from the database, responsive to their respective dwell times being less than a pre-defined threshold.

In some embodiments, the plurality of shopping carts are each attached with at least one of a radio-frequency identification tag or a beacon-enabled device, and a barcode.

In some embodiments, the one or more hardware processors can be further configured by machine-readable instructions to receive signals provided by one or more wireless devices deployed along the aisle, responsive to the plurality of shopping carts entering and leaving the aisle, respectively.

In some embodiments, the one or more hardware processors can be further configured by machine-readable instructions to receive signals provided from one or more point-of-sale systems, responsive to the respective bar codes being scanned at the one or more point-of-sale systems.

In yet another aspect, a non-transient computer-readable storage medium having instructions embodied thereon. The instructions are executable by one or more processors to: identify a plurality of shopping carts traveling through an aisle of a retail environment; retrieve information of respective times of the plurality of shopping carts entering the aisle, and respective times of the plurality of shopping carts leaving the aisle; associate the plurality of shopping carts with respective transaction identifications; generate a database comprising the transaction identifications and one or more respective items, the one or more items of each transaction identification comprising at least one of: a dwell time class, respective purchase states of one or more products deployed along the aisle, and respective query states of the one or more products; calculate a respective product conversion rate of each of the transaction identifications based on the database; and provide an aisle product conversion rate for managing product placements in the retail environment based on the respective product conversion rate of each of the transaction identifications.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 a schematic diagram of a retail management system, according to some embodiments;

FIG. 2 is a schematic diagram of a cart and an RFID scanner of the retail management system of FIG. 1, according to some embodiments;

FIG. 3 is a schematic diagram of a point-of-sale (PoS) device and cart of the retail management system of FIG. 1, according to some embodiments;

FIG. 4 is a schematic diagram of a virtual personal assistant (VPA) machine and QR code tag of the retail management system of FIG. 1, according to some embodiments;

FIG. 5 is a block diagram of a supply chain controller of the retail management system of FIG. 1, according to some embodiments;

FIG. 6 is a flow chart of an example method for managing a retail environment, according to some embodiments; and

FIG. 7 is a block diagram of a computing device, according to some embodiments.

### DETAILED DESCRIPTION

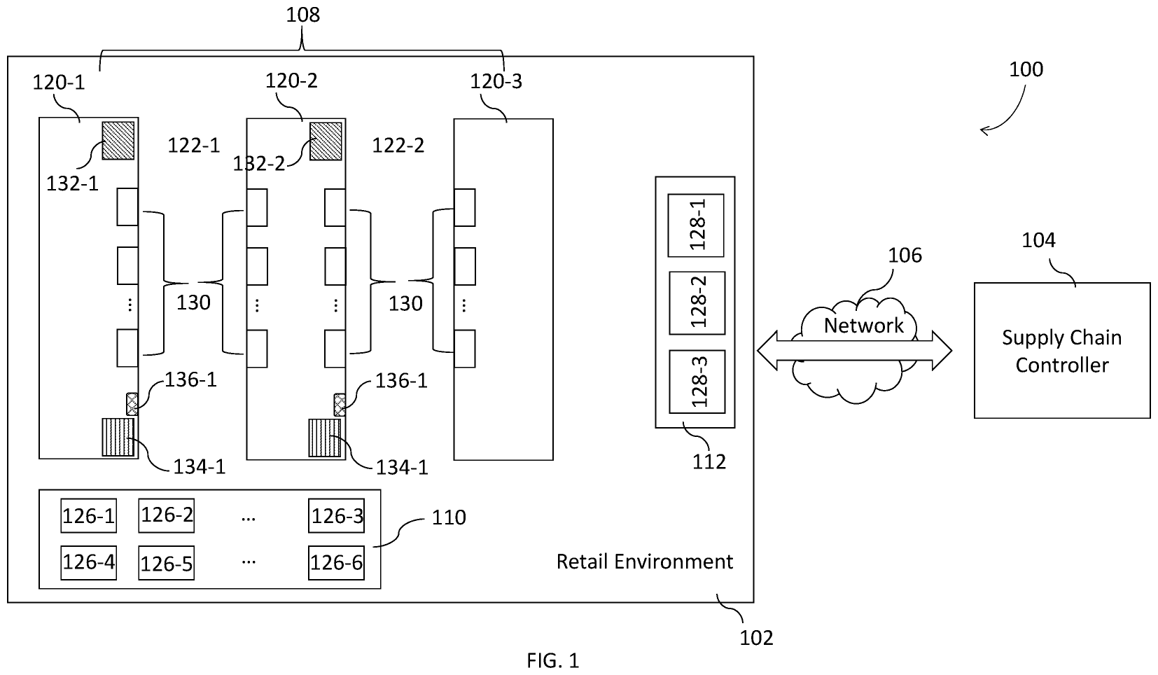

Referring to FIG. 1, a retailer management system 100 is shown, in accordance with some embodiments. The retailer management system 100 can include a shopping facility or retail environment 102 managed by a supply chain controller 104. One or more of the devices deployed within the retail environment 102 can communicate, interface with, or otherwise interact with the supply chain controller 104 via a network 106 to allow the supply chain controller 104 to track, monitor, or manage the retail environment 102, which shall be discussed in further detail below. The network 106 can include one or more component or functionality of a transport network (e.g., a wired network, wireless network, cloud network, local area network, metropolitan area network, wide area network, public network, private network, and the like) or some other network or Internet communication channel.

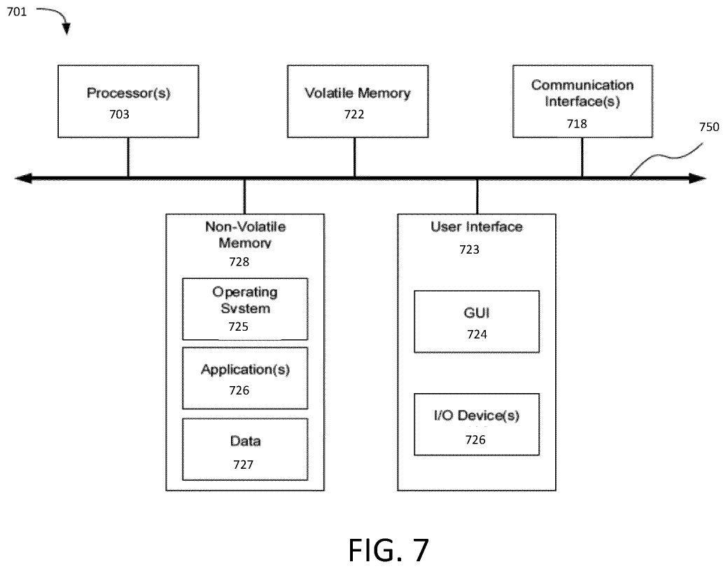

In some embodiments, the supply chain controller 104 may be hosted in, or operated by one or more servers. Such a server can include a device and/or computer program that provides functionality for other devices or programs of the retail environment 102 via the network 106. The server can provide or include a cloud service, and can include at least one network device. The at least one network device of the server can include one or more elements of a computing device described above in connection with at least FIG. 7 for instance.

As shown in FIG. 1, the retail environment 102 can include a product area 108, a cart area 110, and a point-of-sale (PoS) area 112, according to some embodiments. In the product area 108, the retail environment 102 can include a plurality of displays (e.g., shelving units) 120-1, 120-2, and 120-3, and between two adjacent displays, an aisle can be defined. For example, between displays 120-1 and 120-2, an aisle 122-1 can be defined; and between displays 120-2 and 120-3, an aisle 122-2 can be defined. Along at least one side, boundary, or wall of each of the displays 120-1 to 120-3, one or more products 130 may be disposed.

In some embodiments, along each of the aisles 122-1 to 122-2, one or more wireless-enabled and/or Internet-of-Things (IoT)-enabled detectors (e.g., a radio frequency identification (RFID) scanner), one or more machine-readable tags (e.g., a barcode tag, or QR code tag), and one or more virtual assistant services (e.g., a virtual personal or private assistant (VPN) machine) may be deployed. In the illustrated embodiment of FIG. 1, along the aisle 122-1, an RFID scanner 132-1, a VPN machine 134-1, and a QR code tag 136-1 can be attached to respective locations of the display 120-1; and along the aisle 122-2, an RFID scanner 132-2, a VPN machine 134-2, and a QR code tag 136-2 can be attached to respective locations of the display 120-1.

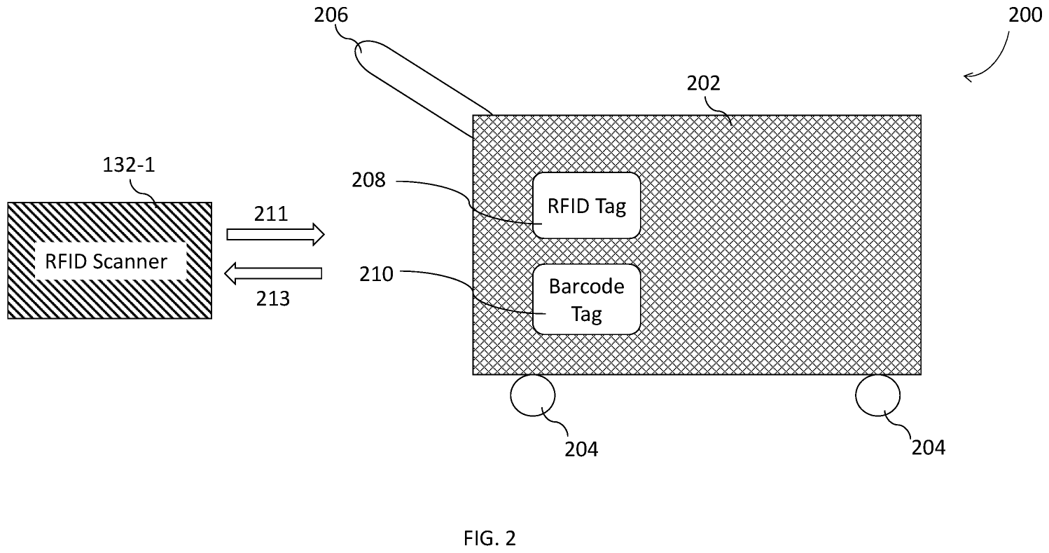

In the cart area 110, the retail environment 102 can include a plurality of trolleys, shopping carts, or carts, 126-1, 126-2, 126-3, 126-4, 126-5, and 126-6. In some embodiments, each of the carts 126-1 to 126-6 can include (e.g., be attached by) one or more machine-readable, wireless-enabled, and/or, IoT-enabled identification tags such as, for example, an RFID tag, a barcode tag, a QR code tag, etc., which shall be discussed in further detail below with respect to FIG. 2.

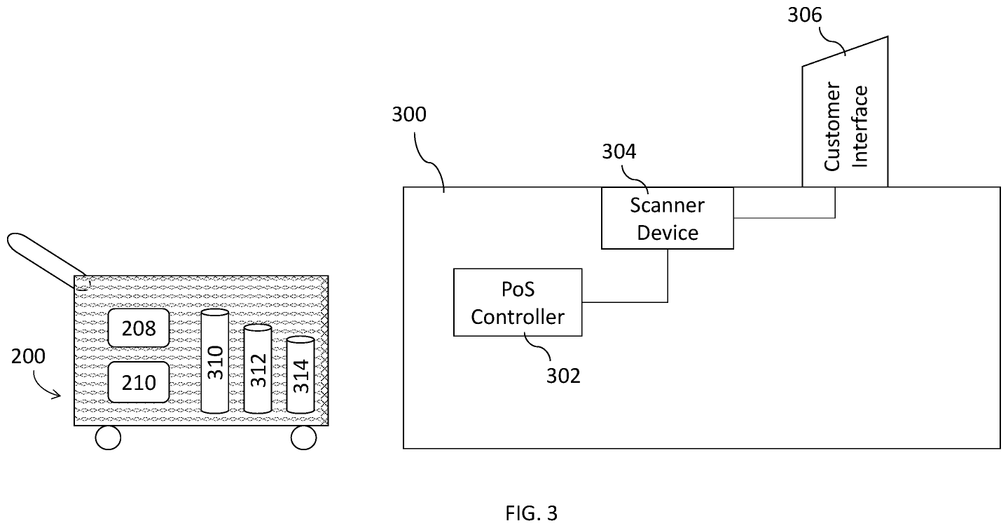

In the PoS area 112, the retail environment 102 can include one or more PoS devices 128-1, 128-2, and 128-3. In some embodiments, each of the PoS devices 128-1 to 128-3 can include one or more fixed or mobile scanning devices, and PoS controllers, which shall be discussed in further detail below with respect to FIG. 3.

When a customer enters the retail environment 102, the customer may get a cart with an RFID tag and barcode tag from the cart area 110 to begin or resume a shopping trip. During the shopping trip, the customer may travel through one or more aisles within the retail environment 102, which can be detected by the respective RFID scanner(s) that are deployed along the aisles. The customer may query information of one or more products, which can be managed or answered by the respective VPN machine(s) that are deployed along the aisles. The customer may purchase one or more products, which can be managed or logged by one or more PoS devices. According to some embodiments of the present disclosure, each of the above-mentioned devices, machines, or controllers of the retail environment 102 can communicate with the supply chain controller 104. As such, the supply chain controller 104 can obtain various information as to whether a product has been queried, whether a queried product has been purchased, and/or any other customer's shopping experiences, which can advantageously help an administrator of the retail environment to better estimate product conversion rate and/or aisle product conversion rate. Details of the supply chain controller 104 shall be discussed in further detail below.

Referring to FIG. 2, a schematic diagram of an exemplary cart 200 is shown. In some embodiments, the functionalities and/or components of each of the carts 126-1-6, as shown in FIG. 1, are substantially similar to the exemplary cart 200. As each of the RFID scanners 132-1-2 of FIG. 1 has a substantially similar functionality to one another, the RFID scanner 132-1 is used as a representative example in the following discussions for illustrating the functionalities and/or components of the cart 200.

As shown in FIG. 2, the cart 200 can include a basket 202, one or more wheels 204, a handle bar 206, an RFID tag (or any of the machine-readable, wireless-enabled, and, IoT-enabled identification tags) 208, and a barcode tag (or any of the machine-readable, wireless-enabled, and, IoT-enabled identification tags) 210. In some embodiments, the RFID tag 208 can be attached or coupled to any suitable part of the cart 200 such as, for example, the handle bar 206 or the basket 202. Similarly, the barcode tag 210 can be attached or coupled to any suitable part of the cart 200 such as, for example, the handle bar 206 or the basket 202.

In some embodiments, a customer may use the cart 200 to travel through a retail environment by optionally gripping the handle bar 206 to move the cart 200 via rotating one or more of the wheels 204; and the customer may retrieve desired product(s) to be placed in the basket 202. Although not shown, the cart 200 can include any of various other components (e.g., a spring, a display device, a wheel support structure, a sensor, etc.) that may be directly or indirectly used by the customer while remaining within the scope of the present disclosure.

In some embodiments, the RFID tag 208 is associated with a respective cart identification (hereinafter “cart ID”) of the cart 200, and the barcode tag 210 is associated with the cart ID. When the cart 200 is in the proximity of the RFID scanner 132-1 (or any of the wireless-enabled and/or Internet-of-Things (IoT)-enabled detectors), the RFID scanner 132-1 can expose the RFID tag 208, attached to the cart 200, to electromagnetic radiation (e.g., one or more wireless signals 211) that activates (e.g., powers) the RFID tag 208. Responsive to the one or more wireless signals 211, the RFID tag 208 can perform various operations. For example, the RFID tag 208 may transmit one or more wireless signals 213, which can include the cart ID, to the RFID scanner 132-1. As such, the RFID scanner 132-1 can function as an interrogator to retrieve information associated with the cart 200 (e.g., cart ID) via the RFID tag 208.

The RFID scanner 132-1 may record, monitor, or log a first time when the RFID scanner 132-1 can start to retrieve the cart ID, and record a second time when the RFID can no longer retrieve the cart ID (e.g., the cart 200 may travel outside the detectable range of the wireless signals 211 and/or 213). According to some embodiments, the first time may correspond to the time (“entering time”) when the cart 200 enters the aisle along which the RFID scanner 132-1 is deployed (e.g., aisle 122-1); and the second time may correspond to the time (“leaving time”) when the cart 200 leaves the aisle along which the RFID scanner 201 is deployed (e.g., aisle 122-1). The RFID scanner 132-1 may provide such information (e.g., the cart ID, and corresponding entering and leaving times) to the supply chain controller 104 via the network 106. As such, the supply chain controller 104 can identify or determine the cart ID of each of the carts traveling in a retail environment to monitor or determine a time period of each of the carts dwelling (“dwell time”) in an aisle by interacting with the RFID scanner deployed along that aisle, which shall be discussed in further detail below.

Referring again to FIG. 2, in some embodiments, the barcode tag 210 is associated with the cart ID of the cart 200. As shall be discussed below, responsive to determining the cart ID and respective dwell time of each of the carts traveling in a retail environment, the supply chain controller 104 can associate each of the carts with a transaction or invoice identification (hereinafter “transaction ID”) by interacting with one or more PoS devices.

Referring to FIG. 3, a schematic diagram of an exemplary PoS device 300 that can be used in the retail environment 102 is shown. In some embodiments, the functionalities and/or components of each of the PoS devices 128-1-3, as shown in FIG. 1, are substantially similar to the exemplary PoS device 300. The cart 200 of FIG. 2 is used in the following discussions for illustrating the functionalities and/or components of the PoS device 300.

As shown in FIG. 3, the PoS device 300 can include a PoS controller 302, a scanning device 304, and a customer interface 306. In some embodiments, the employee of a retail environment, or a customer shopping in the retail environment may access the customer interface 306 to identify the cart ID of a cart (e.g., cart 200) used by the customer via using the scanning device 304 to scan the barcode tag 210 attached to the cart 200. The employee of the retail environment, or the customer shopping in the retail environment may access the customer interface 306 to generate a transaction ID via using the scanning device 304 to scan respective identifications of the products (e.g., 310, 312, and 314) placed in or on the cart 200, and/or pay the amount in association with the transaction ID. As such, the transaction ID may include information purchase states of the products 310-314. In some embodiments, the customer may use the scanning device 304 to scan a personal device of the customer (e.g., a loyal card, and/or a personal handheld device) to allow certain personal information (e.g., a name, an address, an age, etc.) to associate with the transaction ID.

Accordingly, the PoS controller 302, communicatively coupled to the scanning device 304, can log such information (e.g., cart ID, transaction ID, and/or personal information) and/or provide the information to the supply chain controller 104 via the network 106. The supply chain controller 104 can associate the cart ID with the transaction ID, which shall be discussed in further detail below.

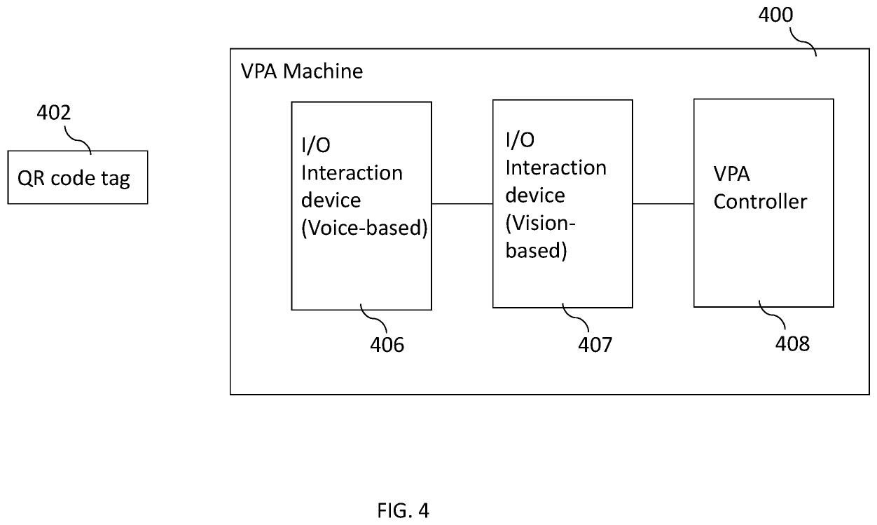

Referring to FIG. 4, a schematic diagram of an exemplary VPN machine 400 and a QR code tag 402 that can be used in the retail environment 102 is shown. In some embodiments, the functionalities and/or components of each of the 134-1-2, as shown in FIG. 1, are substantially similar to the exemplary VPN 400; and the functionalities and/or components of each of the 136-1-2, as shown in FIG. 1, are substantially similar to the exemplary QR code tag 402.

As shown in FIG. 4, the VPN machine 400 can include one or more input/output (I/O) interaction devices 406 and 407, and a VPN controller 408. The I/O interaction devices 406 and 407 may each be a voice-based device (e.g., a microphone) and/or a vision-based device (e.g., a touchscreen). In some embodiments, the VPN machine 400 is deployed along an aisle of a retail environment, and in the proximity to the VPN machine 400, the QR code tag 402, which can include a QR code for accessing the VPN machine 400, can be deployed.

In some embodiments, prior to the customer making a query through the VPN machine 400, the customer may use a personal handheld device to scan the QR code of the QR code tag 402 to be allowed to use the VPN machine 400, and simultaneously or subsequently the customer may enter a cart ID of the cart that the customer is currently using into the VPN machine 400. In response to scanning the QR code and entering the cart ID, the customer can query various product information of each of the products in a retail environment, query general information as to the retail environment, and/or ask for assistance from employee(s) or administrator(s) of the retail environment by using the VPN machine 400, which shall be discussed as follows.

In some embodiments, the VPN controller 408 of the VPN machine 400 can access to a database storing inventory information (e.g., a price, a promotion, a stocked amount, etc.) of each of the products in the retail environment, information of the respective location of each of the products in the retail environment, and the like. The VPN controller 408 can directly communicate with an administrator or employee of the retail environment.

Accordingly, when a customer makes a query for product information and/or administrator's attention by using the VPN machine 400, the customer may use at least one of the I/O interaction devices 406 and 407 to provide inputs and/or feedbacks. In response to receiving the inputs or feedbacks by at least one of the I/O interaction devices 406 and 407, the VPN controller 408, communicatively with the I/O interaction devices 406 and 407, can respond accordingly. In the example where a customer queries along which aisle a product is placed, in response to receiving the query through at least one of the I/O interaction devices 406 and 407, the VPN controller 408 can retrieve corresponding information from a database that stores the inventory information, as described above, and provide the corresponding information to the customer through at least one of the I/O interaction devices 406 and 407. The VPN controller 408 can be hosted on or operated by one or more servers that are the same as or different from the ones hosting the supply chain controller 104. In some embodiments, the VPN controller 408 can record or log the cart ID and the respective query states of one or more products associated with the cart ID (e.g., what kind of query), and provide such information to the supply chain controller 104 via the network 106. As shall be discussed in further detail below, the supply chain controller 104 can associate the information of query states with the above-mentioned information provided by the RFID scanners and PoS devices, respectively, to generate a database for calculating an aisle product conversion rate.

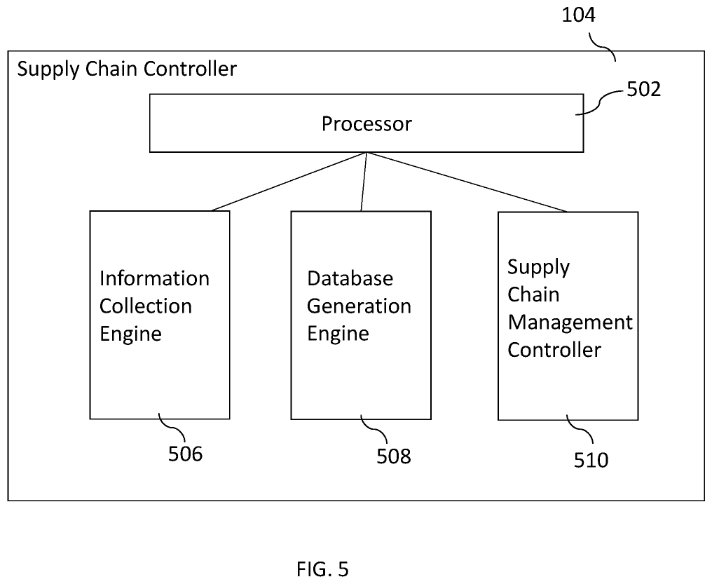

Referring to FIG. 5, depicted is a block diagram of one embodiment of the supply chain controller 104, in accordance with some embodiments. The supply chain controller 104 can include one or more processors 502, a I/O interface device 504, an information collection engine 506, a database generation engine 508, and a supply chain management engine 510. The components or engines of the supply chain controller 104 can be communicatively coupled to one another via a data bus, or the like. The supply chain controller 104 can use the I/O interface device 504 to communicate with other devices such as, for example, RFID scanners, PoS devices, and/or VPA machines of a retail environment.

Each of the above-mentioned elements or entities is implemented in hardware, or a combination of hardware and software, in one or more embodiments. Each component or engine of the supply chain controller 104 can be implemented using hardware or a combination of hardware or software detailed above in connection with FIG. 7. For instance, each of these elements or entities can include any application, program, library, script, task, service, process or any type and form of executable instructions executing on hardware of a device (e.g., the supply chain controller 104). The hardware includes circuitry such as one or more processors in one or more embodiments.

In accordance with some embodiments of the present disclosure, the one or more processors 502 may execute the information collection engine 506 to collect various information from one or more devices of a retail environment (e.g., RFID scanners, PoS devices, and VPA machines). The one or more processors 502 may execute the database generation engine 508 to generate a database based on the collected information. The one or more processors 502 may execute the supply chain management engine 510 to calculate one or more product conversion rates and aisle product conversion rates, according to the generated data base. The information collection engine 506, database generation engine 508, and supply chain management engine 510 shall be respectively discussed in further detail below.

In some embodiments, the information collection engine 506 can collect, log, monitor, identify, or determine various information from each of the RFID scanners, PoS devices, and VPA machines deployed in a retail environment. The information collection engine 506 can collect information regarding aisles, carts, and times by communicating with one or more RFID scanners of the retail environment. The information collection engine 506 can collect information regarding query states by communicating with one or more VPA machines of the retail environment. The information collection engine 506 can collect information regarding purchase states by communicating with one or more PoS devices of the retail environment.

Using the retail environment 102 of FIG. 1 as an example, the information collection engine 506 can communicate with the RFID scanners 132-1-2 deployed at aisles 122-1-2 to collect information as to which of the carts 126-1-6 is or are used by one or more customers to travel through the retail environment 102, which of the aisles 122-1-2 is or are visited or traveled through by one or more of the carts 126-1-6, and respective entering and leaving times of each of the carts 126-1-6 visiting or traveling through one of the aisles 122-1-2.

Continuing with the above example, when the cart 126-1 is used to travel through the aisle 122-1, the RFID scanner 132-1 can communicate with the RFID tag attached to the cart 126-1 (as described above with respect to FIG. 2) to retrieve the cart ID of cart 126-1, and may provide the cart ID of cart 126-1 to the information collection engine 506 through the I/O interface device 504. As such, the information collection engine 506 can identify the cart 126-1 by receiving the cart ID of cart 126-1. Similarly, the information collection engine 506 can identify one or more other carts in response to receiving their respective cart IDs from the RFID scanners. Further, in some embodiments, each aisle of the retail environment 102 is deployed with one or more respective RFID scanners, so that in response to receiving a cart ID from an RFID scanner, the information collection engine 506 can identify along which aisle the RFID scanner is deployed so as to collect the information as to which cart travels through which aisle. Still further, in some embodiments, in response to identifying a cart or cart ID, each of the RFID scanners deployed across the retail environment 102 can collect the entering time and leaving time of the cart. The RFID scanners can provide the entering and leaving times of each of the carts to the information collection engine 506, so that the information collection engine 506 can collect the information as to how much time each cart spends traveling through one or more aisles. Table I shown below provides an example of the above-described time information collected by the information collection engine 506 for the aisle 120-1.

TABLE I

| Cart ID | Entering Time | | Leaving Time | |
|---|---|---|---|---|
| 126-1 | 11:40 | AM | 11:44 | AM |
| 126-2 | 12:50 | PM | 12:55.5 | PM |
| 126-3 | 1:10 | PM | 1:10.8 | PM |
| 126-4 | 3:41 | PM | 3:43.2 | PM |
| 126-5 | 5:14 | PM | 5:21 | PM |
| 126-6 | 6:12 | PM | 6:12.5 | PM |

Continuing with the example of the retail environment 102 of FIG. 1, the information collection engine 506 can communicate with the VPA machines 134-1-2 deployed across the retail environment 102 to obtain, receive, monitor, or determine various query states provided by the respective VPA machines. For example, during a shopping trip of a customer using the cart 126-1, the customer may access the VPA machine 134-1, deployed along aisle 134-1, by scanning the QR code tag 136-1 associated with the VPA machine 134-1. Simultaneously or subsequently, in some embodiments, the customer can enter the cart ID of the cart 126-1 into the VPA machine 134-1. In response to being allowed to use the VPA machine 134-1, the customer can make one or more queries to the VPA machine 134-1 such as, for example, the location of a product, the price of a product, a request for attention of an employee or administrator of the retail environment, etc.

The VPA machines deployed across the retail environment 102 can log, record, or collect such queries from each of the customers, and the respective cart ID. In response, according to some embodiments, the information collection engine 506 can communicate with the VPA machines to collect the one or more queries associated with each of the cart IDs. In some embodiments, such queries collected by the information collection engine 506 may be referred to as query states. Table II shown below provides an example of the above-described query state information collected by the information collection engine 506 for the aisle 120-1 along which products of eggs, milk, cookies, and yogurt are placed.

TABLE II

| Cart ID | Eggs | Milk | Cookies | Yogurt |
|---|---|---|---|---|
| 126-1 | None | Location | Customer | None |
| | | | Support | |
| | | | Needed | |
| 126-2 | None | Location | None | None |
| 126-3 | More Options | None | None | None |
| 126-4 | Price | Price | None | None |
| 126-5 | More Options | Location | Price | Price |
| 126-6 | None | None | None | None |

Continuing with the example of the retail environment 102 of FIG. 1, the information collection engine 506 can communicate with the PoS devices 128-1-3 deployed at the PoS area 112 of the retail environment 102 to obtain, receive, monitor, or determine various purchase states provided by the respective PoS devices. For example, when a customer using the cart 126-1 is done with his or her sopping, the customer or an employee of the retail environment may use one of the PoS devices to generate a transaction ID that can include the respective purchase states of one or more products by scanning each of the one or more products. The customer or the employee may use the PoS device to obtain the cart ID of cart 126-1 by scanning the barcode tag attached to the cart 126-1, as described above with respect to FIG. 3. In response, the information collection engine 506 can communicate with the PoS devices to collect the one or more purchase states associated with the transaction ID and the cart ID, and associate the transaction ID with the cart ID. Table III shown below provides an example of the above-described purchase state information collected and/or associated by the information collection engine 506 for the aisle 120-1, wherein “1” represents that the product is purchased and “0” represents that the product is not purchased.

TABLE III

| Transaction | | | | | |
|---|---|---|---|---|---|
| ID | Cart ID | Eggs | Milk | Cookies | Yogurt |
| 1 | 126-1 | 1 | 1 | 0 | 1 |
| 2 | 126-2 | 0 | 1 | 1 | 0 |
| 3 | 126-3 | 0 | 1 | 0 | 0 |
| 4 | 126-4 | 0 | 0 | 1 | 0 |
| 5 | 126-5 | 1 | 0 | 1 | 1 |
| 6 | 126-6 | 0 | 0 | 0 | 0 |

In some embodiments, the database generation engine 508 can generate a database by associating the respective information collected by the information collection engine 506. The database generation engine 508 can associate the time information (e.g., Table I), the query state information (e.g., Table II), and the purchase state information (e.g., Table III) as to each of the transaction ID/cart ID to generate a database for each of aisles of a retail environment. The database generation engine 508 can determine a dwell time of each transaction ID/cart ID by calculating a difference between respective entering and leaving times. In some embodiments, such a dwell time may correspond to how much time the customer of each transaction ID/cart ID spends along the aisle.

The database generation engine 508 can classify the dwells times of the transaction IDs/cart IDs into a number of categories such as, for example, a traversed time category, a short time category, a medium time category, and a long time category. In some embodiments, the database generation engine 508 can classify the dwell times by using one of the following techniques: a decision tree technique, a logistic regression technique, a k-NN (k-nearest neighbors) technique, a random forest classifier technique, and the like. The database generation engine 508 can selectively filter out the transaction ID/cart ID that is classified into the traversed time category or associated with a dwell time that is below a certain threshold, according to a predefined rule.

Table IV shown below provides an example of such a database, generated by the database generation engine 508, according to the information collected by the information collection engine 506 for the aisle 120-1. As shown in Table IV, each transaction ID/cart ID can correspond to a number of items such as, for example, a time category, respective purchase states of one or more products, and respective query states of the one or more products.

TABLE IV

| Trans- | | Dwell | Time | Eggs, | Milk, | Cookies, | Yogurt, |
|---|---|---|---|---|---|---|---|
| action | Cart | Time | Cate- | Query | Query | Query | Query |
| ID | ID | (mins) | gory | State | State | State | State |
| 1 | 126-1 | 4 | Me- | 1, | 1, | 0, | 1, |
| | | | dium | None | Lo- | Customer | None |
| | | | | | cation | Support | |
| | | | | | | Needed | |
| 2 | 126-2 | 5.5 | Me- | 0, | 1, | 1, | 0, |
| | | | dium | None | Lo- | None | None |
| | | | | | cation | | |
| 3 | 126-3 | 0.8 | Short | 0, | 1, | 0, | 0, |
| | | | | More | None | None | None |
| | | | | Options | | | |
| 4 | 126-4 | 1.2 | Short | 0, | 0, | 1, | 0, |
| | | | | Price | Price | None | None |
| 5 | 126-5 | 7 | Long | 1, | 0, | 1, | 1, |
| | | | | More | Lo- | None | None |
| | | | | Options | cation | | |
| 6 | 126-6 | 0.5 | Tra- | 0, | 0, | 0, | 0, |
| | | | versed | None | None | None | None |

In some embodiments, the supply chain management engine 510 can calculate a product conversion rate of each of the transaction IDs/cart IDs and use the product conversion rates of a number of transaction IDs/cart IDs to calculate an aisle product conversion rate based on the database created by the database generation engine 508. The product conversion rate may be defined as the number of product(s) of a transaction ID/cart ID being queried and purchased (the numerator) divided by the number of product(s) of the transaction ID/cart ID being queried (the denominator). In some embodiments, the supply chain engine 510 may determine the number of product(s) of a transaction ID/cart ID being queried by counting the number of products, associated with the transaction ID/cart ID, whose corresponding query states are not presented as “none;” and determine the number of product(s) of a transaction ID/cart ID being queried and purchased by counting the number of products, associated with the transaction ID/cart ID, whose corresponding query states are not presented as “none” and purchase states are presented as “1.”

For example, the product conversion rate of the transaction ID “1”/cart ID “126-1” may be calculated as 50% as for this transaction ID/cart ID, milk and cookies are queried (resulting the denominator to be a value of 2) and among milk and cookies, only milk is purchased (resulting the numerator to be a value of 1). In another example, the product conversion rate of the transaction ID “2”/cart ID “126-2” may be calculated as 100% as for this transaction ID/cart ID, milk is queried (resulting the denominator to be a value of 1) and the milk is purchased (resulting the numerator to be a value of 1). In yet another example, the product conversion rate of the transaction ID “5”/cart ID “126-5” may be calculated as 100% as for this transaction ID/cart ID, eggs, milk, cookies, and yogurt are queried (resulting the denominator to be a value of 4) and among the queried products, all are purchased (resulting the numerator to be a value of 4).

In response to calculating the product conversion rate of each of the transaction ID/cart ID included in the database for an aisle, the supply chain management engine 510 can calculate an aisle product conversion rate based on the product conversion rates of the transaction IDs/cart IDs included in the database for the aisle. Continuing with the above example, in response to determining the transaction IDs from 1 to 5 corresponding to product conversion rates of 50%, 100%, 100%, 100%, and 100%, respectively (transaction ID 6 may be filtered out as described above), the supply chain management engine 510 can determine the aisle product conversion rate for this particular aisle is 90% by averaging the product conversion rates of the transaction IDs 1 to 5. Following the same principle, the supply chain management engine 510 can calculate the aisle product conversion rate of each of the aisles across the retail environment.

According to some embodiments, the supply chain controller 104 or the supply chain management engine 510 can provide such a product conversion rate and aisle product conversion rate to the administrator of a retail environment. The administrator can selectively update the locations of one or more products, assign more or less employees responsive to one or more certain aisles, update the information that can be provided by one or more VPA machines deployed across the retail environment, etc., based on the calculated conversion rates.

Further, in some embodiments, the supply chain management engine 510 can estimate a query behavior of each of the products of the retail environment based on the database (e.g., Table IV). The supply chain management engine 510 may use one or more association rule learning techniques (e.g., an apriori algorithm technique, an eclat algorithm technique, an FF-growth algorithm technique, etc.) to calculate a support value indicative of how frequently one or more items appear in the database, and based on the support value, estimate a confidence value indicative of how often a rule has been found to be true or valid. The supply chain management engine 510 may use the confidence value to represent the query behavior for a certain product.

For example, the supply chain management engine 510 can use the database (Table IV) to calculate a first support value indicating out of the total number of 5 transactions, the number of transactions that customers have spent time, classified in the medium time category, to purchase milk (e.g., 2 transactions in this example). As such, the supply chain management engine 510 can calculate the first support value as 0.4 (2/5). In response to calculating the first support value, the supply chain management engine 510 can quantize a query behavior indicating how often a customer actually purchases milk when the customer has spent the time, classified in the medium time category, and made a query by estimating the respective confidence value. The supply chain management engine 510 can calculate a second support value indicating out of the total number of 5 transactions, the number of transactions that customers have made queries and spent time, classified in the medium time category, to purchase milk (e.g., 2 transactions in this example). As such, the supply chain management engine 510 can calculate the second support value as 0.4 (2/5). In some embodiments, the supply china management engine 510 can quantize the query behavior (e.g., how often a customer actually purchases milk when the customer has spent the time, classified in the medium time category, and made a query) by calculating a confidence value. The confidence value can be calculated as a ratio of the calculated second support value to the first support value. In this example, the supply chain management engine 510 can calculate the confidence value as 100% (0.4/0.4).

According to some embodiments, the supply chain controller 104 or the supply chain management engine 510 can provide such confidence values of one or more query behaviors to the administrator of a retail environment. The administrator can selectively update the locations of one or more products, assign more or less employees responsive to one or more certain aisles, update the information that can be provided by one or more VPA machines deployed across the retail environment, etc., based on the confidence values. In the above example, based on the 100% confidence value, the administrator may determine that the milk is not placed in an appropriate location as out of 100 times a customer spends a medium time period to actually purchase milk, 100 times the customer still makes a query about the location of milk. Thus, in response to receiving the 100% confidence value, the administrator may update the location of milk and/or assign more employees responsive to the aisle along which the milk is placed.

Further, in some embodiments, the supply chain management engine 510 can estimate a strength of each of the aisles of the retail environment based on a database (e.g., Table IV). Based on the database, the supply chain management engine 510 can derive various query rules or behaviors as to each of the aisles such as, for example, whether the location where a query is made is relevant to the location of a product, whether a query is answered, whether a query for a product is answered and the product is purchased, etc. In response to the provisions of the query rules, the supply chain management engine 510 can use one or more of the above-described association rule learning techniques to calculate the confidence value for each of the query rules. In some embodiments, the supply chain engine 510 can aggregate the respective confidence values of the query rules to estimate the strength of each of the aisles.

Continuing with the above example where a 100% confidence value of the query behavior or rule, the supply chain management engine 510 can further determine a confidence value of a first query rule, e.g., whether the location where a query is made is relevant to the location of a product. Based on the database, the supply chain management engine 510 may determine the confidence value of the first query rule to be about 40%. In some embodiments, the supply chain management engine 510 may determine a negative trait of this aisle as 100% subtracting the confidence value, in the current example, 60% (100%-40%). The supply chain management engine 510 can further determine a confidence value of a second query rule, e.g., whether each customer is satisfied with the feedback (provided by the VPA machine) to his or her query. The supply chain management engine 510 may determine the confidence value of the second query rule as 55%, according to the database. In some embodiments, the supply chain management engine 510 may calculate an average value of the respective confidence values of these query rules, for example, (100%+60%+55%=71.6%). In some embodiments, the supply chain management engine 510 can compare the average value with a predefined threshold (e.g., 60%) to determine the strength of this aisle. For example, if the average value is greater than the threshold (the current example), the supply chain management engine 510 may classify the aisle as a strong aisle. On the other hand, if the average value is less than or equal to the threshold, the supply chain management engine 510 may classify the aisle as a weak aisle.

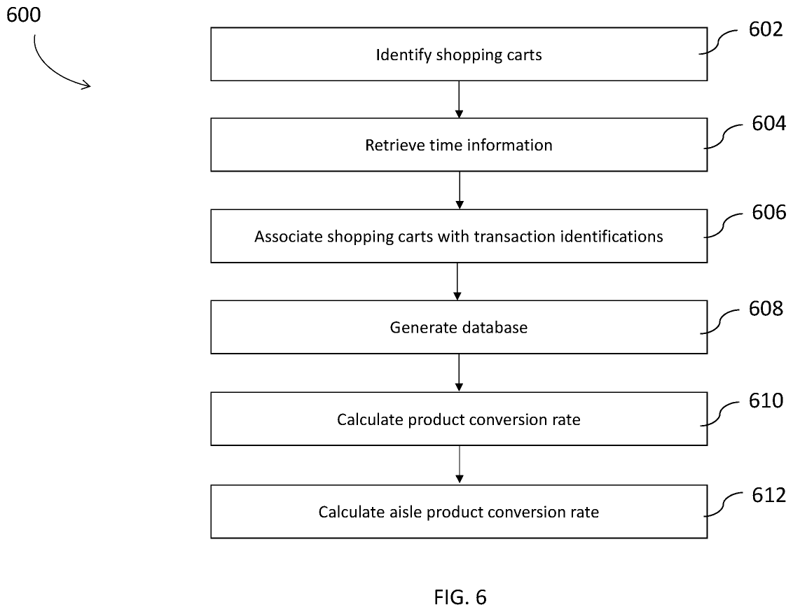

Referring to FIG. 6, depicted is a flow diagram of one embodiment of a method 600 for managing a retail environment. The functionalities of the method 600 can be implemented using, or performed by, the components detailed herein in connection with FIGS. 1-5.

At operation 602, a supply chain controller (e.g., 104) can identify a plurality of shopping carts. In some embodiments, an information collection engine of the supply chain controller can identify the plurality of shopping carts that travel through a retail environment by communicating with one or more RFID scanners deployed along respective aisles of the retail environment. An RFID scanner may retrieve the cart ID of each of the carts that travels through the aisle along which the RFID scanner is deployed. The information collection engine may collect such information from the RFID scanners deployed across the retail environment.

At operation 604, the information collection engine can retrieve respective time information of the plurality of carts. In some embodiments, in response to retrieving the cart ID of each of the carts, the RFID scanner can monitor the respective times that the carts enter and leave the aisle along which the RFID scanner is deployed. The information collection engine may collect such time information of each of the carts that enters and leaves one or more aisles from the respective RFID scanners deployed across the retail environment.

At operation 606, the supply chain controller can associate the identified shopping carts with respective transaction identifications. In some embodiments, the information collection engine can collect respective purchase states of one or more products associated with each of a number of transaction IDs from one or more PoS devices of the retail environment. The one or more PoS devices may generate the transaction ID for each of the cart IDs. In response to receiving the purchase states of one or more products with respect to each of the transaction IDs/cart IDs, a database generation engine of the supply chain controller can associate the cart IDs with respective transaction IDs that include respective purchase states of one or more products.

In some embodiments, the information collection engine can collect respective query states of one or more products associated with each of the cart IDs from one or more VPA machines of the retail environment. In response to receiving the query states of one or more products with respect to each of the cart IDs, the database generation engine of the supply chain controller can associate the cart IDs with respective query states of the one or more products.

In some embodiments, the database generation engine can calculate a dwell time of each of the carts for an aisle of the retail environment by determining a difference between respective entering and leaving times of each of the carts for the aisle. The database generation engine may use a classification technique to classify the dwell times into a number of dwell time categories, and filter out one or more dwell time categories based on a predefined threshold.

At operation 608, the database generation engine can generate a database. In some embodiments, the database generation engine can generate a database in which each of the cart ID is associated with a respective transaction ID. As such, in the database, each transaction ID/cart ID can include a number of items such as, for example, respective dwell times, respective query states of one or more products, respective purchase states of the one or more products.

At operation 610, a supply chain management engine of the supply chain controller can calculate a product conversion rate. In some embodiments, the supply chain management engine can use the database to calculate a product conversion rate of each of the transaction IDs/cart IDs for each of the aisles of the retail environment, as discussed above with reference to FIG. 5.

At operation 612, the supply chain management engine can calculate an aisle product conversion rate. In some embodiments, the supply chain management engine can use calculated a product conversion rates of the transaction IDs/cart IDs for each of the aisles of the retail environment to calculate the respective aisle production conversion rate, as discussed above with reference to FIG. 5.

Referring to FIG. 7, a block diagram of computer 701 is depicted. Computer 701 can include one or more processors 703, volatile memory 722 (e.g., random access memory (RAM)), non-volatile memory 728 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 723, one or more communications interfaces 718, and communication bus 750. User interface 723 can include graphical user interface (GUI) 724 (e.g., a touchscreen, a display, etc.) and one or more input/output (I/O) devices 726 (e.g., a mouse, a keyboard, a microphone, one or more speakers, one or more cameras, one or more biometric scanners, one or more environmental sensors, one or more accelerometers, etc.). Non-volatile memory 728 stores operating system 715, one or more applications 716, and data 717 such that, for example, computer instructions of operating system 715 and/or applications 716 are executed by processor(s) 703 out of volatile memory 722. In some embodiments, volatile memory 722 can include one or more types of RAM and/or a cache memory that can offer a faster response time than a main memory. Data can be entered using an input device of GUI 724 or received from I/O device(s) 726. Various elements of computer 701 can communicate via one or more communication buses, shown as communication bus 750. In various implementations disclosed herein, instructions may be stored on a computer or machine-readable storage medium such as memories 728 and 722. Instructions may be stored on a non-transitory computer or machine-readable storage medium. As utilized herein, the term “non-transitory” indicates only that the medium does not include signals in space; any other type of computer or machine-readable storage medium is contemplated within the scope of a “non-transitory” computer or machine-readable storage medium unless otherwise indicated.

Computer 701 as shown in FIG. 7 is shown merely as an example, as controller, clients, servers, intermediary and other networking devices and can be implemented by any computing or processing environment and with any type of machine or set of machines that can have suitable hardware and/or software capable of operating as described herein. Processor(s) 703 can be implemented by one or more programmable processors to execute one or more executable or machine-readable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A “processor” can perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” can be analog, digital or mixed-signal. In some embodiments, the “processor” can be one or more physical processors or one or more “virtual” (e.g., remotely located or “cloud”) processors. A processor including multiple processor cores and/or multiple processors multiple processors can provide functionality for parallel, simultaneous execution of instructions or for parallel, simultaneous execution of one instruction on more than one piece of data.

Communications interfaces 718 can include one or more interfaces to enable computer 701 to access a computer network such as a Local Area Network (LAN), a Wide Area Network (WAN), a Personal Area Network (PAN), or the Internet through a variety of wired and/or wireless or cellular connections.

In some embodiments, each of the above-mentioned engines, elements or entities is implemented in hardware, or a combination of hardware and software, in one or more embodiments. Each component of supply chain controller 104 can be implemented using hardware or a combination of hardware or software detailed above in connection with FIG. 7.

For instance, each of these engines, elements or entities can include any application, program, library, script, task, service, process or any type and form of executable instructions executing on hardware of a device (e.g., supply chain controller 104). The hardware includes circuitry such as one or more processors in one or more embodiments.

Although the present embodiments have been particularly described with reference to preferred ones thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. A method for managing products in a retail environment, the method comprising:
identifying a plurality of shopping carts traveling through an aisle of a retail environment;
retrieving information of respective times of the plurality of shopping carts entering the aisle, and respective times of the plurality of shopping carts leaving the aisle;
associating the plurality of shopping carts with respective transaction identifications;
generating a database comprising the transaction identifications and one or more respective items, the one or more items of each transaction identification comprising at least one of: a dwell time class, respective purchase states of one or more products deployed along the aisle, and respective query states of the one or more products;
calculating a respective product conversion rate of each of the transaction identifications based on the database; and
providing an aisle product conversion rate for managing product placements in the retail environment based on the respective product conversion rate of each of the transaction identifications.

2. The method of claim 1, wherein calculating a respective product conversion rate of each of the transaction identifications comprises:
dividing a number of products, associated with each of the transaction identifications, that are queried and purchased by a number of products, associated with each of the transaction identifications, that are queried.

3. The method of claim 2, further comprising:
determining the number of products, associated with each of the transaction identifications, that are queried and purchased according to the respective purchase states of one or more products associated with the transaction identification and the respective query states of the one or more products associated with the transaction identification; and
determining the number of products, associated with the transaction identification, that are queried according to the respective query states of the one or more products associated with the transaction identification.

4. The method of claim 1, further comprising:
calculating respective dwell times spent by the plurality of shopping carts traveling through the aisle based on the respective times of the plurality of shopping carts entering the aisle and respective times of the plurality of shopping carts leaving the aisle; and
grouping the plurality of shopping carts into respective dwell time classes.

5. The method of claim 4, further comprising:
filtering out one or more shopping carts from the database, responsive to their respective dwell times being less than a pre-defined threshold.

6. The method of claim 1, wherein the plurality of shopping carts are each attached with at least one of a radio-frequency identification tag or a beacon-enabled device, and a barcode.

7. The method of claim 6, wherein retrieving the information of respective times of the plurality of shopping carts entering the aisle and respective times of the plurality of shopping carts leaving the aisle comprises:
receiving signals provided by one or more wireless devices deployed along the aisle, responsive to the plurality of shopping carts entering and leaving the aisle, respectively.

8. The method of claim 6, wherein associating the plurality of shopping carts with respective transaction identifications comprises:
receiving signals provided from one or more point-of-sale systems, responsive to the respective bar codes being scanned at the one or more point-of-sale systems.

9. The method of claim 1, further comprising receiving the respective query states of the one or more products associated with each of the transaction identifications, responsive to receiving identifications of the plurality of shopping carts from a virtual private assistant.

10. The method of claim 1, further comprising:
based on the database, using an association rule learning technique to estimate a confidence value indicative of a query behavior of a product placed in the aisle.

11. The method of claim 10, further comprising:
taking an action to update a location of the product, responsive to receipt of the confidence value.

12. A system, comprising:
one or more hardware processors configured by machine-readable instructions to:
identify a plurality of shopping carts traveling through an aisle of a retail environment;
retrieve information of respective times of the plurality of shopping carts entering the aisle, and respective times of the plurality of shopping carts leaving the aisle;
associate the plurality of shopping carts with respective transaction identifications;
generate a database comprising the transaction identifications and one or more respective items, the one or more items of each transaction identification comprising at least one of: a dwell time class, respective purchase states of one or more products deployed along the aisle, and respective query states of the one or more products;
calculate a respective product conversion rate of each of the transaction identifications based on the database; and
provide an aisle product conversion rate for managing product placements in the retail environment based on the respective product conversion rate of each of the transaction identifications.

13. The system of claim 12, wherein the one or more hardware processors are further configured by machine-readable instructions to:
divide a number of products, associated with each of the transaction identifications, that are queried and purchased by a number of products, associated with each of the transaction identifications, that are queried.

14. The system of claim 13, wherein the one or more hardware processors are further configured by machine-readable instructions to:
determine the number of products, associated with each of the transaction identifications, that are queried and purchased according to the respective purchase states of one or more products associated with the transaction identification and the respective query states of the one or more products associated with the transaction identification; and
determine the number of products, associated with the transaction identification, that are queried according to the respective query states of the one or more products associated with the transaction identification .

15. The system of claim 12, wherein the one or more hardware processors are further configured by machine-readable instructions to:
calculate respective dwell times spent by the plurality of shopping carts traveling through the aisle based on the respective times of the plurality of shopping carts entering the aisle and respective times of the plurality of shopping carts leaving the aisle; and
group the plurality of shopping carts into respective dwell time classes.

16. The system of claim 15, wherein the one or more hardware processors are further configured by machine-readable instructions to:
filter out one or more shopping carts from the database, responsive to their respective dwell times being less than a pre-defined threshold.

17. The system of claim 12, wherein the plurality of shopping carts are each attached with at least one of a radio-frequency identification tag or a beacon-enabled device, and a barcode.

18. The system of claim 17, wherein the one or more hardware processors are further configured by machine-readable instructions to:
receive signals provided by one or more wireless devices deployed along the aisle, responsive to the plurality of shopping carts entering and leaving the aisle, respectively.

19. The system of claim 17, wherein the one or more hardware processors are further configured by machine-readable instructions to:
receive signals provided from one or more point-of-sale systems, responsive to the respective bar codes being scanned at the one or more point-of-sale systems.

20. A non-transitory computer-readable storage medium having instructions embodied thereon, the instructions being executable by one or more processors to:
identify a plurality of shopping carts traveling through an aisle of a retail environment;
retrieve information of respective times of the plurality of shopping carts entering the aisle, and respective times of the plurality of shopping carts leaving the aisle;
associate the plurality of shopping carts with respective transaction identifications;
generate a database comprising the transaction identifications and one or more respective items, the one or more items of each transaction identification comprising at least one of: a dwell time class, respective purchase states of one or more products deployed along the aisle, and respective query states of the one or more products;
calculate a respective product conversion rate of each of the transaction identifications based on the database; and
provide an aisle product conversion rate for managing product placements in the retail environment based on the respective product conversion rate of each of the transaction identifications.
